(19) United States
(12) Patent Application Publication
(10) Pub. No.: US 2008/0188618 A1
(43) Pub. Date: Aug. 7, 2008

(54) Porous Acrylate Copolymer Films and Uses Therefor

(76) Inventors: Matthew P. Greving, Phoenix, AZ (US); Neal Woodbury, Phoenix, AZ (US); Trent Northern, San Diego, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/018,398

(22) Filed: Jan. 23, 2008

Related U.S. Application Data
(60) Provisional application No. 60/897,222, filed on Jan. 23, 2007.

(51) Int. Cl. C08F 222/10; C08F 222/38

(52) U.S. Cl. 525/55; 427/240; 526/307.2; 526/307.7; 526/320; 526/329.5

(57) ABSTRACT

The present invention provides novel porous copolymer films, compositions comprising such films, methods for making such films, and pre-polymerization mixes that can be used for making such films.

### CROSS REFERENCE

This application claims priority to U.S. Provisional Patent Application Ser. No. 60/897,222 filed Jan. 23, 2007, incorporated by reference herein in its entirety.

### STATEMENT OF GOVERNMENT INTEREST

This work was supported at least in part by grant number 015551-001 from the Department of Energy. Thus, the U.S. government has certain rights in the invention.

### BACKGROUND OF THE INVENTION

Microarrays and DNA arrays in particular have become ubiquitous tools for biomolecular research. High density arrays with several hundred thousand different DNA sequences are commercially available. These microarrays are typically comprised of a planar substrate (e.g. silanized glass) upon which DNA or RNA are covalently attached. Each element has a known position and sequence, therefore the array encodes the identity of each array element by its spatial position⁵ allowing the parallel analysis of thousands of sequences after incubating with complementary fluorescently labeled oligonucleotides.

Another important and growing application of microarrays is for multiplexed protein detection. While oligonucleotides can function as affinity materials (aptamers), DNA microarrays are typically not used for detecting protein binding. Peptides make excellent affinity materials and arrays of peptide ligands may provide alternative high throughput methods. However, extension of light-directed synthetic methods commonly used for DNA array construction to peptide array construction have proven challenging. Currently, the majority of peptide arrays are constructed using a technique called SPOT-synthesis, where peptides are synthesized in situ on membrane supports (i.e. filter paper) by sequentially spotting the various amino acids and coupling reagents to construct the desired peptide array. In contrast to the monolayer arrays which have low site densities (10-50 pmole/cm²)² SPOT synthesis results in much higher site density, typically 0.1 to 1 gmol/cm². This greatly facilitates characterization vs. monolayer arrays which are typically limited to characterization using the small set of short peptide specific monoclonal antibodies. However, typically SPOT synthesis results in large feature sizes (0.1-1 mm), which limits this approach to construction of arrays with 1,000 of elements.

Since peptide combinatorial space is much larger than DNA (base 20 vs base 4) many applications for peptide arrays require comparison of large numbers of peptides. Thus, there is a need in the art for improved arrays and surfaces for peptide array analysis.

### SUMMARY OF THE INVENTION

In one aspect, the present invention provides continuous copolymer films comprising at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate.

In various embodiments, the two or more monomers are selected from the group consisting of HEMA, MMA, and EDMA monomeric subunits.

In another aspect, the present invention provides compositions comprising a substrate; and a continuous copolymer film of the invention formed over the substrate.

In another aspect, the present invention provides methods for making a continuous copolymer film, comprising copolymerizing at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate. In various embodiments, the two or more monomers are selected from the group consisting of HEMA, MMA, and EDMA monomeric subunits.

In another aspect, the present invention provides pre-polymerization mixes comprising at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate. In various embodiments, the two or more monomers are selected from the group consisting of HEMA, MMA, and EDMA monomeric subunits.

### BRIEF DESCRIPTION OF THE FIGURES

FIG. 1. SEM images of porous polymer nanostructure. (A) Polymer made with porogenic solvents is comprised of large (>100 nm) pores. (B) Spin coated polymer made with polymeric porogens with smaller (<100 nm) pores and is estimated to be 1 um thick using confocal microscopy.

### DETAILED DESCRIPTION OF THE INVENTION

In one aspect, the present invention provides continuous copolymer films comprising at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate.

As used herein, a polymer is a macromolecular substance composed of repeating monomeric subunits, and includes linear, branched, and cross-linked polymers, and combinations thereof. As used herein, a copolymer is a polymer composed of two or more different monomeric units. The copolymer can comprise block copolymers, graft copolymers, alternating copolymers, and random copolymers.

As used herein, a block copolymer is a polymer composed of linear segments containing one or more monomers of the same type, which are covalently attached to at least one other segment containing one or more monomers of a different type. As used herein, a graft copolymer comprises one or more polymer chains (comprising one or more monomeric subunits) to which are covalently attached, along their backbone, one or more linear or branched chains containing one or more monomer units. As used herein, an alternating copolymer comprises polymer chains containing either alternating monomers of a different type or alternating blocks of monomers of different type. As used herein, a random copolymer comprises two or more monomer units that do not occur along the backbone in an alternating fashion.

In one embodiment, the copolymers comprise random copolymers, where the different monomeric subunits are present in specific ratios, i.e. a ratio of 1:9 means that, on average, for every 10 monomer units 1 of those units will be monomer ‘A’ and the other 9 will be monomer ‘B’. Such copolymers provide control of the average spacing between specific monomeric subunits within the polymer, but do not necessarily generate exact repeating patterns of monomers

In another embodiment, the copolymer may be a mixture of two or more kinds of copolymers, or a mixture of at least one copolymer and other monomeric subunits. As used herein the term “continuous” means that the average density of reactive sites or locations at which reactive sites may be created on or in the copolymer film is similar across the entire copolymer film (ie: within 50%). Thus, for example, where the average reaction site density is 1 nanomoles per square centimeter, the density across the entire copolymer film can range between 0.50 nanomoles and 1.50 nanomoles per square centimeter. In various embodiments, the density for reaction sites across the entire copolymer film are within 45%, 40%, 35%, 30%, 25%, 20%, 15%, 10%, 5%, 4%, 3%, 2%, 1%, or are identical).

As used herein a “reactive site” is a location on or within the film at which a desired reaction, including but not limited to molecule binding, synthesis, or chemical modification can occur, or which can be processed so that such reactions can occur. Thus, reactive sites may be present upon polymerization, or, the copolymer may be processed to introduce reactive sites following polymerization. In a non-limiting embodiment, amine functional groups can be formed in situ after polymerization by forming ester bonds between hydroxyl groups on the copolymer and a compound that contains both a carboxylic acid and a primary amine (i.e. amino acids). As will be understood by those of skill in the art, there are many other possible chemistries that those of skill in the art would be aware of that would allow one to introduce reactive sites after polymerization.

Thus, in a further embodiment, the composition further comprises a plurality of reactive sites on or in the copolymer film. As will be understood by those of skill in the art, such reactive sites may be on the surface of the copolymer film or may be located within the copolymer film. In a further embodiment, the reactive sites are homogenous, ie: identical reactive sites over the entire copolymer. In various further embodiments, the density of reactive sites ranges from 100 picomoles to 100 nanomoles per square centimeter; the density of such reactive sites can be modified as disclosed herein to a desired density. Reactive site density can be controlled, for example, by polymerizing a mixture of monomeric subunits, some of which contain reactive sites and others that do not, where their ratio determines the reactive site density. In another example, one can polymerize monomeric subunits according to the invention that contain reactive sites only, and later reduce reactive site density by chemically terminating a fraction of the reactive sites. For example, after polymerization, the method could comprise covalently coupling a mixture of glycine (active) and acetyl-glycine (terminally inactive)—the ratio of these two determine the reactive site density of the final polymer

The resulting copolymer films can be used to prepare high density arrays (also referred to herein as “microarrays”) of any molecule of interest, including but not limited to nucleic acids, polypeptides, lipids, and carbohydrates. Thus, in a further embodiment, the copolymer films comprise a high density array of molecules attached to the copolymer film. The density of such molecules on the arrays can be varied as desired; in one embodiment, the density is approximately 100 picomoles-100 nanomoles of molecules arrayed per square centimeter. In one embodiment, peptide microarrays of up to 100,000 elements (on a surface area of 1 cm×1.5 cm) can be synthesized with adequate resolution. There are no specific synthetic methods required to achieve the densities disclosed herein. The copolymers of the invention are optically transparent during the synthesis and this property of the polymer helps facilitate production of high density arrays.

The reactive sites can be engineered to include numerous functional groups, including but not limited to amines (primary, secondary, tertiary), sulfhydryls, carboxylic acids, hydroxyl groups, and azides. In one example, the polymer's pendant hydroxyl groups are esterified with glycine. Hydroxyl groups provide flexibility in that they can be used to attach peptides, oligonucleotides, lipids and carbohydrates. Furthermore, hydroxyls can be converted to other reactive groups using standard chemistries i.e. amines, carboxylic acids, aldehydes, etc. In a further embodiment, the reactive sites are capable of covalently binding to amino acid residues.

In one embodiment, the copolymer film comprises two or more monomers selected from the group consisting of HEMA, MMA, and EDMA. In a further embodiment, the copolymer film comprises HEMA and EDMA. In various embodiments, the copolymer film comprises between 21:3:3 HEMA:MMA:EDMA (w:w:w) and 1:3:3 HEMA:MMA:EDMA (w:w:w); between 14:3:3 HEMA:MMA:EDMA (w:w:w) and 1:3:3 HEMA:MMA:EDMA (w:w:w); between 7:3:3 HEMA:MMA:EDMA (w:w:w) and 1:3:3 HEMA:MMA:EDMA (w:w:w); between 24:1:24 HEMA:MMA:EDMA (w:w:w) and 1:2:1 HEMA:MMA:EDMA (w:w:w); between 24:1:24: HEMA:MMA:EDMA (w:w:w) and 8:1:6 HEMA:MMA:EDMA (w:w:w); between 12:1:12: HEMA:MMA:EDMA (w:w:w) and 8:1:6 HEMA:MMA:EDMA (w:w:w); between 12:1:12: HEMA:MMA:EDMA (w:w:w) and 8:1:3 HEMA:MMA:EDMA (w:w:w); between 24:1:24 HEMA:MMA:EDMA (w:w:w) and 10:1:8 HEMA:MMA:EDMA (w:w:w); between 12:1:12 HEMA:MMA:EDMA (w:w:w) and 10:1:4 HEMA:MMA:EDMA (w:w:w); between 12:1:12 HEMA:MMA:EDMA (w:w:w) and 8:1:3 HEMA:MMA:EDMA (w:w:w); between 12:1:12 HEMA:MMA:EDMA (w:w:w) and 1:2:1 HEMA:MMA:EDMA (w:w:w); between 12:1:12 HEMA:MMA:EDMA (w:w:w) and 1:1:1 HEMA:MMA:EDMA (w:w:w); or between 12:1:12: HEMA:MMA:EDMA (w:w:w) and 2:1:2 HEMA:MMA:EDMA (w:w:w). In various further embodiments, the copolymer film comprises between 7:1 HEMA:EDMA (w:w:w) and 1:7 HEMA:EDMA (w:w:w); between 6:1 HEMA:EDMA (w:w:w) and 1:6 HEMA:EDMA (w:w:w); between 5:1 HEMA:EDMA (w:w:w) and 1:5 HEMA:EDMA (w:w:w); between 3:1 HEMA:EDMA (w:w:w) and 1:3 HEMA:EDMA (w:w:w); between 7:1 HEMA:EDMA (w:w:w) and 1:1 HEMA:EDMA (w:w:w); between 6:1 HEMA:EDMA (w:w:w) and 1:1 HEMA:EDMA (w:w:w); between 5:1 HEMA:EDMA (w:w:w) and 1:1 HEMA:EDMA (w:w:w); between 7:1 HEMA:EDMA (w:w:w) and 1:2 HEMA:EDMA (w:w:w); between 6:1 HEMA:EDMA (w:w:w) and 1:2 HEMA:EDMA (w:w:w); or between 5:1 HEMA:EDMA (w:w:w) and 1:2 HEMA:EDMA (w:w:w).

The copolymer (including any crosslinker) contains 80% or more by weight of the monomeric subunits, and preferably, at least 85%, 90%, 91%, 92%, 93%, 94%, 95%, 96%, 97%, 98%, 99%, or more by weight of the polymerized monomeric subunits.

The thickness of the copolymer films can range from 0.5 um to 30 um. In one embodiment, the thickness of the copolymer film is similar across the entire film (ie: within 50%). Thus, for example, where the average film is 1 um, the thickness across the entire copolymer film can range between 0.50 um and 1.50 um. In various embodiments, the thickness across the entire copolymer film are within 45%, 40%, 35%, 30%, 25%, 20%, 15%, 10%, 5%, 4%, 3%, 2%, 1%, or are identical).

The copolymer films of the invention are porous. As used herein, “porous” means that the copolymer includes void space (ie: pores). In one embodiment, the pore size of the pores in the copolymer ranges between 5 nm and 1 um. In various further embodiments, the porosity of the copolymer ranges between 10 and 99%; and can be tuned depending on the stability required for the application, since as the porosity increases the stability of the polymer decreases. Porosity of the copolymer films can be varied by adjusting the concentration of a polymeric porogen (including but not limited to poly-vinylacetate) in the monomer solution. Such porogens can be any suitable porogen, including any large molecule that will not become part of the co-polymer structure (including but not limited to proteins, poly-vinylacetate, long-chain alcohols (i.e. dodecanol), glycerol, poly-vinylalcohol, etc.

The porosity of the copolymer film can be tuned (as discussed in more detail below) to enhance the avidity of a specific analyte: small pores (ie: tens of nm diameter) for small molecules, moderate pores (approximately 100 nm diameter) for large molecules (i.e. proteins) and large pores (approximately 1 μm) for viruses or cells. Tuning the porosity also provides the capability to regulate diffusion rates in the film—this can be useful in many experiments such as trapping catalytic products or containing a small ‘microenvironment’ within the film (i.e. a small region with low pH). The increased avidity afforded by tuning the porosity of the copolymer film will decrease the limit of detection for a specific analyte by at least a factor of 100,000. Microarrays on the copolymer films of the present invention showed high signal from the polypeptide-based analyte at concentrations as low as 25 fM—about a 1,000,000 fold lower concentration than what could be detected on a similar microarray where the same polypeptide was spotted by hand on a glass substrate (˜25 nM detection limit on glass).

In another aspect of any of the copolymer films of the invention, the films may be formed over a substrate. Any suitable substrate can be used, including but not limited to optical fibers, nitrocellulose, nylon, glass, quartz, diazotized membranes (paper or nylon), silicones, polyformaldehyde, cellulose, cellulose acetate, paper, ceramics, metals, metalloids, semiconductive materials, plastics such as polyethylene, polypropylene, and polystyrene; and gel-forming materials, such as proteins (e.g., gelatins), lipopolysaccharides, silicates, agarose, polyacrylamides, methylmethacrylate polymers; sol gels; porous polymer hydrogels; and nanostructured surfaces; nanotubes (such as carbon nanotubes).

The interaction by which the copolymer film is formed over a surface of the substrate can be of any type, including but not limited to various covalent and non-covalent attachments; bare substrates (such as a bare slide) could be used, or the substrate can first be coated with other layers as desired.

In one embodiment, the compositions are used as a substrate for microarray synthesis (in situ or spotted arrays). The copolymer film has very low autofluorescence, low nonspecific binding, and is compatible with most organic and aqueous solvents. When wet, the copolymer film is optically transparent in the transmission wavelength range of glass (and is generally optically transparent from 350 nm wavelength through the visible spectrum) and exhibits minimal light scattering. Standard spin-coating and curing procedures are used to deposit and polymerize the film on functionalized substrates, such as glass slides, resulting in high surface uniformity and the ability to adjust film thicknesses within a large range (from 0.5 um to 30 um). The porous copolymer film shows dramatically enhanced analyte detection when compared to glass; several experiments have shown detection limits>100,000 fold lower than that of glass.

The resulting compositions of the invention provide a very versatile, inexpensive, clear, non-fluorescent substrate that can be used, for example, for light directed molecular synthesis, and provides approximately 10,000 times as much molecule synthesized on the co-polymer film in the end as a monolayer on glass for the same area. This has allowed us to synthesize peptides and perform mass spectroscopy on the material, and has allowed us to see binding of femtomolar quantities of target proteins (proteins that bind to the peptide being made), even when the dissociation constant is in the tens to hundreds of nanomolar range.

Furthermore, the resulting compositions possess the following features:
It is three dimensional (in one embodiment, the copolymer film is approximately 1 micron thick and synthesis occurs throughout the material);
It can be spun to a very uniform thickness on glass or other flat substrates;
It is completely transparent in the visible spectrum, and in the near ultraviolet spectrum down to about 350 nm;
It has an extremely low inherent fluorescence;
It is photo-polymerizable, meaning that the substrate itself can be patterned on a surface in three dimensions;
It has a very high density of reactive sites, as discussed above;
It can be used with standard synthetic methods using, for example, photolabile linkers;
The products made are plentiful enough to be analyzed by mass spectroscopy, which requires at least picogram quantities for detection;
It is mechanically tough and chemically resistant (except to very strong acid) and stable at temperatures of at least 60° C. for prolonged times;
It is biocompatible (one could put live cells or tissue on it); and
It allows rapid diffusion so that materials involved either in the synthesis or in the interaction with other materials (such as proteins that bind) occurs rapidly (generally within minutes).

In another aspect, the present invention provides pre-polymerization mixes for preparing the copolymer films of the invention, wherein the pre-polymerization mix comprises at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate. In further embodiments, the pre-polymerization mix comprises two or more monomers selected from the group consisting of HEMA, MMA, and EDMA. In a further embodiment, the pre-polymerization mix comprises HEMA and EDMA. In various embodiments, the pre-polymerization mix comprises between 21:3:3 HEMA:MMA:EDMA (w:w:w) and 1:3:3 HEMA:MMA:EDMA (w:w:w); between 14:3:3 HEMA:MMA:EDMA (w:w:w) and 1:3:3 HEMA:MMA:EDMA (w:w:w); between 7:3:3 HEMA:MMA:EDMA (w:w:w) and 1:3:3 HEMA:MMA:EDMA (w:w:w); between 24:1:24 HEMA:MMA:EDMA (w:w:w) and 1:2:1 HEMA:MMA:EDMA (w:w:w); between 24:1:24: HEMA:MMA:EDMA (w:w:w) and 8:1:6 HEMA:MMA:EDMA (w:w:w); between 12:1:12: HEMA:MMA:EDMA (w:w:w) and 8:1:6 HEMA:MMA:EDMA (w:w:w); between 12:1:12: HEMA:MMA:EDMA (w:w:w) and 8:1:3 HEMA:MMA:EDMA (w:w:w); between 24:1:24 HEMA:MMA:EDMA (w:w:w) and 10:1:8 HEMA:MMA:EDMA (w:w:w); between 12:1:12 HEMA:MMA:EDMA (w:w:w) and 10:1:4 HEMA:MMA:EDMA (w:w:w); between 12:1:12 HEMA:MMA:EDMA (w:w:w) and 8:1:3 HEMA:MMA:EDMA (w:w:w); between 12:1:12 HEMA:MMA:EDMA (w:w:w) and 1:2:1 HEMA:MMA:EDMA (w:w:w); between 12:1:12 HEMA:MMA:EDMA (w:w:w) and 1:1:1 HEMA:MMA:EDMA (w:w:w); or between 12:1:12: HEMA:MMA:EDMA (w:w:w) and 2:1:2 HEMA:MMA:EDMA (w:w:w). In various further embodiments, the copolymer film comprises between 7:1 HEMA:EDMA (w:w:w) and 1:7 HEMA:EDMA (w:w:w); between 6:1 HEMA:EDMA (w:w:w) and 1:6 HEMA:EDMA (w:w:w);between 5:1 HEMA:EDMA (w:w:w) and 1:5 HEMA:EDMA (w:w:w); between 3:1 HEMA:EDMA (w:w:w) and 1:3 HEMA:EDMA (w:w:w); between 7:1 HEMA:EDMA (w:w:w) and 1:1 HEMA:EDMA (w:w:w); between 6:1 HEMA:EDMA (w:w:w) and 1:1 HEMA:EDMA (w:w:w); between 5:1 HEMA:EDMA (w:w:w) and 1:1 HEMA:EDMA (w:w:w); between 7:1 HEMA:EDMA (w:w:w) and 1:2 HEMA:EDMA (w:w:w); between 6:1 HEMA:EDMA (w:w:w) and 1:2 HEMA:EDMA (w:w:w); or between 5:1 HEMA:EDMA (w:w:w) and 1:2 HEMA:EDMA (w:w:w).

The pre-polymerization mix is preferably stored in the dark at low temperature (ie: approximately 4° C.) to avoid unwanted polymerization.

In various further embodiments, the pre-polymerization mix may further comprise a suitable amount of porogen, as described above

In a further aspect, the present invention provides methods for making the copolymer films of the invention, comprising polymerizing the monomeric subunits to produce the copolymer films disclosed above. In a further embodiment, the methods comprise depositing the copolymer films directly on the substrate using any technique, including but not limited to a spin-coating technique similar to high-throughput methods used in semiconductor fabrication. Spin-coating the films results in a very uniform surface and allows for strict control over the film thickness. Using the spin-coating technique (an example of which is described in detail below), the copolymer film thickness can be optimized for a specific application—thin films of between approximately 0.5 to 1 micron to increase signal-to-noise ratio of complex analyte samples or thick films of between approximately 1 to 10 microns) to maximize analyte capture. Thick polymers (11-30 um) would be very useful in situations where the polymer was used to synthesize compounds that would later be selectively or non-selectively cleaved after synthesis. This would allow one to produce enough material for each compound in the library to measure in solution or other assays off of the surface. In another embodiment, the copolymers are formed in situ through polymerization with a micromirror array.

In another embodiment, the copolymer is polymerized in the presence of silanized glass where, for example, the glass is silanized to have a methacrylate group that can react with the polymer.

The copolymer formulations of the invention have also been tested for characterization of analyte binding to the microarray. Such testing involves determining appropriate porosity, diffusion, and reactive site density for polypeptides to provide a high density array, but not so dense that adjacent synthesized or attached polypeptides interfere with each other. For example, for peptides longer than a five amino acids a spacing of several nanometers helps in synthesis of the peptides by reducing aggregation of neighboring peptides. In a further example in which a HEMA:EDMA copolymer is synthesized (no MMA spacer), after polymerization the reactive group spacing is adjusted by reacting a mixture of terminated and unterminated chemical groups. In a non-limiting example, a 1:1 mixture of Glycine:Acetyl-Glycine can be reacted with the hydroxyl groups on the polymer. This effectively doubles the spacing between reactive groups because half of the hydroxyls were terminated with Acetyl-Glycine and the other half contain Glycine and are still reactive (still contain a primary amine). This method could be used in a number of ratios with a number of modifications to allow for fine tuning of reactive group spacing.

Methods for calculating an average reactive group spacing by using chemical modeling/drawing software are known to those of skill in the art. In one embodiment, some length of polymer chain is drawn using the software, followed by placing reactive groups at specific positions based on the monomer ratio used. So if a ratio of 7:3:3 HEMA:MMA:EDMA (w:w:w) was used, one would convert this to molar ratios then draw a polymer chain with several HEMA, MMA, EDMA monomer units evenly distributed in the chain by their respective molar ratio. Once this is drawn one can use the software to measure the distance between HEMA (reactive) units. When monomers of different reactivity are used (that is, one monomer polymerizes faster than the others) the monomer ratio can be adjusted to account for the more rapid polymerization of one monomer in the mixture.

These copolymers have very low autofluorescence, low nonspecific binding and functional group density can be adjusted to maximize results from various characterization methods: FRET, single/multi-color fluorescence, thermographic imaging, AFM, STM and several others. Such adjustments include, but are not limited to altering the attachment site density to avoid fluorescence self-quenching and to avoid interference between neighboring molecules or molecular aggregation on the surface.

For polymerization, the monomeric subunits for use in preparing the copolymers of the invention can be mixed in the desired ratio in the presence of porogen and initiator. The amount of porogen to be used is dependent on the desired porosity of the resulting copolymer.

As noted above, any suitable porogen can be used. Similarly, any suitable initiator can be used as well, including photoinitiators, chemical initiators (TEMED and ammonium persulfate) and thermal initiators.

Any suitable conditions for polymerization (and pre-polymerization treatment of the monomeric solution) can be employed that are compatible with forming the copolymer film on the substrate as described herein. HEMA, MMA, and EDMA (and related copolymers) are soluble in both aqueous and organic solvents, thereby allowing them to be used in a wide range of applications.

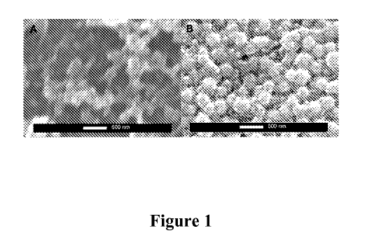

Porous copolymer films can be obtained through phase separation between the monomer solution and the growing polymer using co-solvents (e.g. porogen dissolved in solvent, such as cyclohexanol and 1-dodecanol). Photopolyermization can be accomplished, for example, using a micromirror array or UV lamp or a micromirror array. The latter approach can be used to pattern the porous polymer structures in three-dimensions. In a preferred embodiment, monomers are mixed with nonvolatile porogens dissolved in solvent, and the mixture is spin coated onto the substrate and polymerized using a UV lamp. These porogens are subsequently removed by leaching, using any suitable technique, such as those described in the examples below. SEM images reveal that the spin coated polymer has smaller pores (FIG. 1b) than the polymer formed with porogenic solvents (FIG. 1a). In general, the resulting spin coated copolymer allows rapid diffusion of reagents, has low light scattering, and is more homogeneous than copolymers formed by other techniques. These properties are valuable to high fidelity synthesis of arrays with small features and the subsequent fluorescence-based comparison of array elements.

Following polymerization, the copolymer film can be treated to provide the desired functionality at all or a subset of the reactive sites, as described above and as exemplified in the examples that follow.

The porous polymer gels are found to have high spatial resolution, easily producing features<50 micrometers, where features are defined as any spatially resolved region that contains a known molecule or known ratios of a set of molecules that were spotted or synthesized in situ on the copolymer. This allows the construction of the largest peptide arrays reported. The yields were sufficient for construction of arrays of 15mer peptides and subsequent characterization using MALDI-MS.

The compositions of the invention can be in methods to, for example:
Solid phase or light directed synthesis, such as peptide synthesis;
Production of peptide or other compound type arrays that are used for binding assays to detect compounds of interest (such as polypeptides) from any sample type, such as biological or environmental samples; in such assays (as in other assay types described herein), detection of binding events can be by techniques including but not limited to mass spectrometry and fluorescence spectroscopy;
The surfaces themselves could be used with DNA array synthesis to greatly increase the number of DNA molecules giving much brighter signals;
DNA/gene synthesis and release on these surfaces would greatly benefit from larger amounts of each DNA and larger numbers of DNA oligonucleotides. This coupled with a suitable synthesizer would allow generation of very, very large dsDNA fragments (megabase);
A platform for generating large numbers of random peptides for immunosignaturing or biosignaturing;
A platform for optimizing (via mutagenesis) peptides initially identified from random libraries) for specific binding to the target;
A platform for generating large numbers of designed peptides for immunosignaturing (for example overlapping peptides for a whole genome of a pathogen) or biosignaturing (peptides determined as above that are known to bind things involved in disease);
A platform for the sequential development of multi-site ligands to a particular target (keep adding sections of 5-6 amino acids at a time to a linear chain optimizing for better and better binding as the chain interacts with more and more of the target);
A platform for the parallel development of multi-site ligands to a particular target (add sections as branches on a chain or hub each of which is optimized for binding—for example start with an alpha helix with three sites for addition of peptides and grow one chain after another off of it in different positions selecting for better binding);
A platform for displaying diagnostic arrays of molecules;
A platform for small molecule therapeutic discovery;
In a much more general sense, a method for developing chemical functionality involving anything you can assay for on a surface. A chemically diverse library of molecules can be tested for a certain function; and
In a much more general sense, a method for creating chemically diverse spaces that form a two (or potentially three) dimensional surface over which interactions can be quantified between the molecules fabricated on the surface and some target or targets.

### EXAMPLES

Materials: Calmix2 and N,N-Dimethylformamide (DMF) was from Applied Biosystems Inc. (Foster City, Calif.). 3-(trimethoxysilyl)propyl methacrylate, Cyclohexanol, azo-bis-isobutyronitrile (AIBN), β-mercaptoethanol, piperidine, semicarbazide hydrochloride, dichloromethane (DCM), α-cyano-4-hydroxycinnamic acid, triisopropyl silane (TIS), diisopropylethylamine (DIPEA), polyvinylacetate (PvAc), diethylene glycol dimethyl ether (diglyme), Trifluoroacetic acid (TFA), Acetonitrile, Bovine Serum Albumin (BSA) and Purified Human Transferrin were from Sigma-Aldrich Chemical Co. (Milwaukee, Wis.). Glass coverslips were from Bioptechs (Butler, Pa.). ((α-methyl-2-nitropiperonyl)oxy)carbonyl chloride (MeNPOC-Cl) Cambridge Major Laboratories Inc. (Germantown Wis.). Isopropanol and ethanol (95%) were from ACROS Organics (Geel, Belgium). Bromophenol blue was from Alfa Aesar (Ward Hill, Mass.). Methanol, sulfuric acid, acetic anhydride, hydrochloric acid were purchased from Mallinckrodt Inc. (Paris, Ky.). FMOC amino acids, O-(7-Azabenzotriazol-1-yl)-N,N,N′,N′-tetramethyluroniumhexafluorophosphate (HATU) and tetramethylrhodaminex succinimidyl ester were purchased from Anaspec Inc. (San Jose, Calif.). Fmoc-Rink amide linker and Fmoc-Aminohexanoic acid (Fmoc-Ahx) were from NovaBiochem, a division of EMD Biosciences, Inc. (San Diego, Calif.). Water was purified using an ultrapure filtration system from Barnstead. (Dubuque, Iowa).

Equipment: Spin-coating was done using a Laurell (North Wales, Pa.) WS-400B-6NPP spin processor. UV Curing of spin-coated polymer was performed with a Dymax (Torrington, Conn.) 5000 flood lamp in a Coy (Grass Lake, Mich.) controlled atmosphere glove box. An FCS2 flow chamber from Bioptechs Inc. (Butler, Pa.) was used for all array synthesis reactions. Patterning was performed using an SF-100 digital micromirror device (DMD) maskless exposure system from Intelligent Micro Patterning, LLC, (St. Petersburg, Fl). Peptide synthesis was done using a Milligen 9050 peptide synthesizer, Millipore Co. (Bedford, Mass.). Mass spectrometry was performed on a MALDI-TOF mass spectrophotometer from Applied Biosystems Inc. (Foster City, Calif.) and a Microflex MALDI-TOF, Bruker (Billerica, Mass.). The 380/50 (center wavelength/band width) excitation filter was from Chroma Technologies Corp (Rockingham, Vt.). Spectrophotometry was performed using a Cary 50 UV-Vis spectrophotometer, Varian Inc., (Palo Alto, Calif.). Scanning electron microscopy (SEM) was performed using a XL30ESEM environmental SEM, FEI Co. (Hillsboro, Oreg.) on a sample coated with 3.5 nm palladium/gold or 8 nm gold with accelerating voltages of 3-20 KV. Fluorescence images of peptide microarrays were obtained using a PerkinElmer (Wellesley, Mass.) imager, Amersham Biosciences (Piscataway, N.J.). Array signal analysis was performed with array analysis software from Molecular Devices (Sunnyvale, Calif.).

Glass Surface Functionalization. Glass cover slides were soaked for 30 min at RT with 1/1 (v/v) hydrochloric acid/methanol, then in concentrated sulfuric acid at RT for 30 min and finally in boiling water between 10 and 30 minutes. Between steps, the slides were immersed in nanopure water at RT for 2 minutes. A solution of 5% 3-(trimethoxysilyl)propyl methacrylate in 95% methanol/5% water was prepared and stirred for 1 minute, then the slides were immersed in the silane solution at RT and allowed to react for 1 hour with gentile agitation. Slides were immersed in methanol for 3 minutes and then placed in a 100-150° C. oven. Nitrogen was blown though the oven for ten minutes and the slides were allowed to bake for 12-16 hours.

Spin-coating porous polymer surfaces for high spatial density arrays. Spin-coating and curing was performed in a controlled atmosphere chamber purged with argon. An argon sparged monomer solution containing (w/w) 15% 3:1 HEMA:EDMA, 1% AIBN and 84% porogenic solvent (6% 113 kDa PvAc in diglyme) was spin-coated for 30 seconds at 2,000 rpm on a 40 mm diameter methacrylate functionalized glass slide. The spin-coated monomer was then cured under a high-intensity UV light source (max intensity in the wavelength range 320-390 nm) for 2 minutes. After curing, the surface was soaked in methanol for 12 hours to remove excess monomer and porogen.

Amination of polymer: was performed using 0.075 mmoles Fmoc-amino acid (either Fmoc-Glycine or Fmoc-aminohexanoic acid), 27 mg (0.071 mmoles) HATU, 25 μL (0.15 mmoles) DIPEA, and 475 μL DMF. These were combined and allowed to react for 3 minutes before adding to the aminated surface. The reaction was allowed to go for 1 hr at 50° C.

Similar experiments (not further described herein) in which peptide arrays were prepared and screened were carried out using the following monomer ratios, each of which worked well:

3:1 HEMA:EDMA

10:1:4 HEMA:MMA:EDMA

7:3:3 HEMA:MMA:EDMA (worked particularly well)

Other monomer ratios that have been tested and shown to work according to the methods and compositions of the include

1:1 HEMA:EDMA

6:1 HEMA:EDMA

12:1:12 HEMA:MMA:EDMA

8:1:3 HEMA:MMA:EDMA

In all cases, the synthesis protocol described above can be used, simply by changing the monomer ratios used. Our experiments show that any monomer mixture that had more HEMA than MMA worked particularly well, while mixtures that had more MMA than HEMA were sensitive to temperature during polymerization, where somewhat brittle polymers resulted in the substrate overheated during polymerization. With adequate temperature control of such high ratio MMA copolymers, the resulting polymers would be of good quality.

Automated Peptide Microarray Synthesis. Synthesis of peptide microarrays was done using an automated system comprised of a Milligen 9050 peptide synthesizer complete with an amino acid handler, a Bioptics FCS2 flow through optical chamber, an Intelligent Micropatterning SF-100 DMD, and a computer controlling the peptide synthesizer. After post synthesis workup the microarray was soaked overnight in 1:1:1 Water:Methanol:Acetonitrile to remove synthesis reagents from the porous polymer.

Protein binding to array: To prepare the peptide microarray for polypeptide binding, the microarray was dried then soaked in aqueous buffer solution (1×PBS pH 7.4) for 2 hours at 4° C. The equilibration buffer was poured off and a predetermined volume of buffer solution (1×PBS pH 7.4) containing 2% BSA blocking agent was added and soaked for 2 hours at 4° C. After 2 hours of pre-block the array was briefly washed and a binding buffer (1×PBS pH 7.4) containing 25 μM Alexa647 labeled polypeptide and 1 mg/ml E. coli lysate was incubated with the array for 2 hours on a rocking table. After binding, the array was washed several times with 1×PBS buffer then soaked for 14 hours in PBS gradually reducing the salt concentration (to improve array image quality) over several buffer exchanges during that period.

Fluorescence imaging of array: To prepare the peptide microarray for imaging, the thin film was washed with nanopure water to remove salt on the surface that may affect imaging then dried with a low nitrogen stream. The array was imaged using an imager with standard excitation laser settings for Alexa-647 dye. Imager settings were 5 micron resolution, 43% PMT and 10 micron resolution, 400V PMT respectively.

### Results

Porous polymer support. Monomers HEMA and EDMA were selected for their optical properties and the photoinitiator AIBN has aliphatic photoproducts which are nonfluorescent. The hydroxyl groups on HEMA serve as handles for synthesis through an ester linkage to the first amino acid. Porous structures can be obtained through phase separation between the monomer solution and the growing polymer using cosolvents (e.g. cyclohexanol and 1-dodecanol). Photopolyermization is accomplished using a micromirror array or UV lamp or a micromirror array (FIG. 1). The latter approach can be used to pattern the porous polymer structures in the three-dimensions. However, in general superior performance is observed with spin coated monomer films polymerized using a UV lamp in the presence of nonvolatile polymeric porogens. These porogens are subsequently removed by leaching. SEM images reveal that the spin coated polymer has smaller pores (FIG. 1b) than the polymer formed with porogenic solvents (FIG. 1a). In general, the thin spin coated polymer allows rapid diffusion of reagents, has low light scattering, and is more homogeneous. These properties are valuable for high fidelity synthesis of arrays with small features and the subsequent fluorescence based comparison of array elements.

To provide a chemical handle for synthesis, the polymer's pendant hydroxyl groups are esterified with glycine resulting in a high site density of amino groups (90 nmole/cm²) as determined by benzofulvene-piperidine absorbance. This is roughly 1000-fold higher than the density attainable on the silanized glass substrates used in conventional arrays (<10 pmole/cm²). In fact, fluorescence and solid phase synthesis calorimetric tests (TNBS, ninhydrin, and bromophenol blue) are easily visible to the naked eye, even for 1 micron thick films. The bromophenol blue test provides a nondestructive means for monitoring intermediate reaction yields. This pH sensitive dye reversibly binds to the primary amino groups causing the polymer to turn blue, the dye being displaced upon coupling of subsequent amino acids. Visual inspection provides a rough estimate of reaction progress; however more quantitative fluorescent assays are used for step-wise yield determination.

Design and construction of a peptide affinity array. To test this approach to constructing peptide grafted polymer affinity arrays we conducted polypeptide binding assays. Alexa-647 labeled polypeptide (Gal80) (25 μM) was incubated in a 1 mg/ml E. coli extract (to reduce non-specific surface binding and ensure Gal80 specificity), washed, and the surface was imaged.

### Discussion

While DNA is readily synthesized on glass either porous glass, in the case of solid phase synthesis, or planar glass for constructing microarrays. In contrast, solid phase peptide synthesis utilizes porous polymers. The approach presented here utilizes spatially addressable porous polymer for peptide microarray construction using mixed Fmoc and light-directed synthesis (FIG. 1). The porous polymer gels are found to have high spatial resolution, easily producing features<50 micrometers. This allows the construction of the largest peptide arrays reported. The yields were sufficient for construction of arrays of 15mer peptides and characterization using MALDI-MS.

Perhaps the most surprising result of this work is the high affinity observed for the Gal80 peptide on the porous polymer. The high levels of binding observed at 25 μM target concentration is what might expect for a very good antibody and is 5 orders of magnitude better than the Kd measured using SPR and ELISA assays. It is not clear which properties of the peptide polymer system confer the observed high levels of binding. Possibly this is due to the close proximity of many ligands within the porous polymer, whereby the protein is essentially trapped as it diffuses between a high local concentrations of ligands within the pores.

It is clear that the polymer is an essential part of the affinity material and ligands optimized for surface binding may not be optimum in solution based measurements. While this may make optimization of solution binding using these methods more complex, it points out the power of this approach for taking peptides known to function in other environments and optimizing them for use on a substrate that should prove useful in solid state binding and activity assays.

### CONCLUSION

In conclusion, a new platform has been developed for constructing peptide arrays. This has been used to fabricate the largest in situ synthesized arrays we are aware of. Such an array has been used to optimize a peptide sequence for binding to a target protein, Gal80, on a peptide-polymer gel substrate. This platform may prove particularly useful for optimization of peptide-based probes to be applied to multiplexed protein specific affinity arrays for biomedical diagnostics.

We claim:

1. A continuous copolymer film, wherein the copolymer film comprises at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate.

2. The continuous copolymer film of claim 1 further comprising a plurality of reactive sites on or in the copolymer film.

3. The continuous copolymer film of claim 2 wherein the plurality of reactive sites on or in the copolymer are identical.

4. The continuous copolymer film of claim 2 wherein the density of reactive sites ranges from 100 picomoles to 100 nanomoles per square centimeter.

5. The continuous copolymer film of claim 2 further comprising molecules bound to the reactive sites.

6. The continuous copolymer film of claim 1 wherein the two or more monomers are selected from the group consisting of HEMA, MMA, and EDMA monomeric subunits.

7. The continuous copolymer film of claim 1 wherein the two or more monomers comprise HEMA and EDMA monomeric subunits.

8. The continuous copolymer film of claim 7 wherein the copolymer film comprises between 7:1 HEMA:EDMA (w:w:w) and 1:7 HEMA:EDMA (w:w:w).

9. The continuous copolymer film of claim 8 further comprising a plurality of reactive sites on or in the copolymer film.

10. The continuous copolymer film of claim 9 wherein the plurality of reactive sites on or in the copolymer are identical.

11. The continuous copolymer film of claim 9 wherein the density of reactive sites ranges from 100 picomoles to 100 nanomoles per square centimeter.

12. The continuous copolymer film of claim 9 further comprising molecules bound to the reactive sites.

13. The continuous copolymer film of claim 7 wherein the copolymer film comprises between 21:3:3 HEMA:MMA:EDMA (w:w:w) and 1:3:3 HEMA:MMA:EDMA (w:w:w).

14. The continuous copolymer film of claim 13 further comprising a plurality of reactive sites on or in the copolymer film.

15. The continuous copolymer film of claim 14 wherein the plurality of reactive sites on or in the copolymer are identical.

16. The continuous copolymer film of claim 14 wherein the density of reactive sites ranges from 100 picomoles to 100 nanomoles per square centimeter.

17. The continuous copolymer film of claim 14 further comprising molecules bound to the reactive sites.

18. A composition comprising
(a) a substrate; and
(b) a continuous copolymer film of claim 1 formed over the substrate.

19. A method for making a continuous copolymer film, comprising copolymerizing at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate.

20. The method of claim 19, wherein the two or more monomers are selected from the group consisting of HEMA, MMA, and EDMA monomeric subunits.

21. The method of claim 19 wherein the two or more monomers comprise HEMA and EDMA monomeric subunits.

22. The method of claim 21 wherein the copolymer film comprises between 7:1 HEMA:EDMA (w:w:w) and 1:7 HEMA:EDMA (w:w:w).

23. The method of claim 21 wherein the copolymer film comprises between 21:3:3 HEMA:MMA:EDMA (w:w:w) and 1:3:3 HEMA:MMA:EDMA (w:w:w).

24. A method for preparing a composition, comprising making the continuous copolymer film of claim 19 and depositing it on a substrate.

25. The method of claim 24, wherein the depositing comprises spin coating.

26. A pre-polymerization mix comprising at least two monomeric subunits selected from the group consisting of Methylmethacrylate (MMA), Hydroxyethylmethacrylate (HEMA), Ethyleneglycoldimethacrylate (EDMA), Dimethylacrylamide, Aminopropylmethacrylamide, Bisacrylamide, and Triethyleneglycol Diacrylate.

27. The prepolymerization mix of claim 26, wherein the pre-polymerization mix comprises two or more monomers selected from the group consisting of HEMA, MMA, and EDMA.

28. The prepolymerization mix of claim 26, wherein the pre-polymerization mix comprises HEMA and EDMA.
